(19) United States
(12) Patent Application Publication
(10) Pub. No.: US 2004/0255465 A1
(43) Pub. Date: Dec. 23, 2004

(54) Shaving apparatus

(76) Inventors: Andrew Pennella, Stamford, CT (US); John Franzini, Hollis, NH (US); David E. Roche, Nashua, NH (US)

Correspondence Address: MCCORMICK, PAULDING & HUBER LLP, CITY PLACE II, 185 ASYLUM STREET, HARTFORD, CT, 06103, US

(21) Appl. No.: 10/866,272

(22) Filed: Jun. 11, 2004

Related U.S. Application Data
(60) Provisional application No. 60/480,159, filed on Jun. 20, 2003.
(60) Provisional application No. 60/503,060, filed on Sep. 15, 2003.

(51) Int. Cl. B26B 19/40

(52) U.S. Cl. 30/41; 30/50

(57) ABSTRACT

A shaving apparatus is provided that includes a handle, a razor cartridge, a plurality of shaving aid material doses, a carrier, and an actuator. The razor cartridge includes one or more razor blades, and is attached to the handle. The shaving aid material doses are each in a substantially dehydrated form. The carrier is disposed within the handle, and is operable to carry the shaving aid material doses within the handle. The actuator is operable to move the carrier to a position within the handle wherein at least one of the shaving aid material doses can be hydrated to produce a flowable shaving aid material.

### BACKGROUND OF THE INVENTION

1. Technical Field

The present invention relates to shaving apparatus in general, and to shaving apparatus having a mechanism for providing a flowable shaving aid material in particular.

2. Background Information

Numerous attempts have been made to combine a razor assembly with a mechanism for dispensing shaving aid material. Some prior art devices (e.g., U.S. Pat. Nos. 3,726,009 and 1,899,841) disclose a reservoir disposed in the handle of the device for storing shaving aid material. The shaving aid material is propelled from the reservoir to the head of the device through one or more passages extending therebetween. A problem with providing a reservoir within the handle is that it is often necessary to make the handle uncomfortably large to accommodate a desirable amount of shaving aid material. If the handle is kept to a reasonable size, the volume of shaving aid material provided is undesirably small. Another problem with a shaving device having a reservoir containing a liquid or gel material is leakage.

### DISCLOSURE OF THE INVENTION

According to the present invention, a shaving apparatus is provided that includes a handle, a razor cartridge, a plurality of shaving aid material doses, a carrier, and an actuator. The razor cartridge includes one or more razor blades, and is attached to the handle. The shaving aid material doses are each in a substantially dehydrated form. The carrier is disposed within the handle, and is operable to carry the shaving aid material doses within the handle. The actuator is operable to move the carrier to a position within the handle wherein at least one of the shaving aid material doses can be hydrated to produce a flowable shaving aid material.

An advantage of the present invention shaving apparatus is that it does not require an uncomfortably large handle. During operation of the present shaving apparatus, shaving aid material in a form ready-to-use is created by adding water (e.g., from the shaving environment) to one of the substantially dehydrated doses of shaving aid material. The water combines with the shaving aid material doses to create a flowable material (e.g., a liquid, a gel, etc.) that exits the handle at a predetermined position(s) relative to the razor cartridge. Hence, there is no need to store shaving aid material within an uncomfortably large handle.

Another advantage of the present invention is that the potential for leakage of a liquid or gel from the shaving apparatus when not in use is minimized. Once the user has finished shaving, any remaining shaving aid material can be cleared out or sealed in, consequently the amount of flowable shaving aid material stored within the device is either eliminated or reduced relative to prior art devices. As a result, the potential for leakage is eliminated or reduced.

Still another advantage of the present invention is the convenience provided by eliminating the need for a bulky replacement canister of shaving aid material. The shaving aid material doses can be packaged independently, or along with a carrier for replenishing the shaving apparatus.

These and other objects, features, and advantages of the present invention will become apparent in light of the detailed description of the present invention.

### BRIEF DESCRIPTION OF THE DRAWINGS

FIG. 1 is a diagrammatic front view of the present invention shaving apparatus.

FIG. 2 is a sectioned diagrammatic front view of an embodiment of the present invention shaving apparatus.

FIG. 3 is a sectioned diagrammatic side view of an embodiment of the present invention shaving apparatus, including a ratchet-type actuator.

FIG. 4 is a sectioned diagrammatic front view of an embodiment of the present invention shaving apparatus.

FIG. 5 is a sectioned diagrammatic front view of an embodiment of the present invention shaving apparatus.

### DETAILED DESCRIPTION OF THE INVENTION

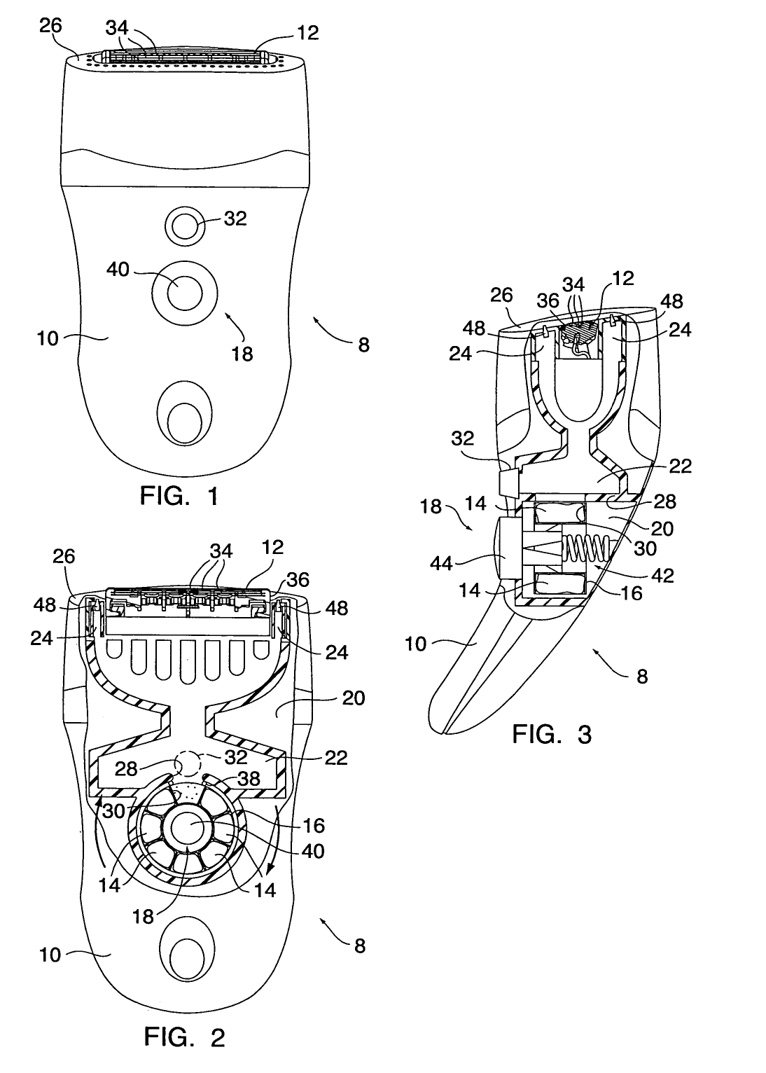

Referring now to FIG. 1-4, the shaving apparatus 8 includes a handle 10, a razor cartridge 12, a plurality of shaving aid material doses 14, a carrier 16, and an actuator 18.

The handle 10 shown in FIG. 14 has an ergonomically shaped exterior contour and an interior cavity 20. A reservoir 22 is disposed within the cavity 20. One or more passages 24 extend between the reservoir 22 and the surface 26 of the shaving apparatus 8 adjacent the razor cartridge 12. The passages 24 are sized to permit flow of shaving aid material from the reservoir 22 to the surface 26 of the shaving apparatus 8 adjacent the razor cartridge 12. A carrier aperture 28 is disposed in the reservoir 22 and is aligned with the carrier 16. The carrier aperture 28 is sized to permit fluid communication between the reservoir 22 and a compartment 30 of the carrier 16 as will be described below. A water fill aperture 32 is disposed in the reservoir 22 to permit the introduction of water, or other liquid, into the reservoir 22 from the exterior of the apparatus 8.

The razor cartridge 12 includes one or more razor blades 34 attached to a frame 36. The razor cartridge 12 can be fixedly or pivotally attached to the handle 10. A variety of different razor cartridges 12 can be used with the present shaving apparatus 8, including those that are intended to be disposable. The present apparatus is not, therefore, limited to any particular type of razor cartridge 12.

The shaving aid material doses 14 include, but are not limited to, lubricating agents, drag reducing agents, depilatory agents, cleaning agents, medicinal agents, soap materials, and the like, including combinations thereof, that enhance the shaving process. The doses 14 are in a dehydrated form that can be hydrated (or rehydrated) to produce a form of shaving aid material that has utility during the shaving process. For example, certain dehydrated doses 14 are of the type that can be hydrated into liquid form. Other dehydrated doses 14 are of the type that can be hydrated into gel or cream form. Each dose 14 represents an amount of dehydrated material that is pre-measured to provide a desirable amount of hydrated material.

The carrier 16 includes a plurality of individual compartments 30 linked together. The plurality of compartments 30 can be disposed in a variety of arrangements. In the embodiment shown in FIG. 2, the compartments 30 are arranged in a wheel. In other embodiments, the compartments 30 may be arranged in string (e.g., linearly or arcuately shaped). The carrier 16 is not limited to any particular arrangement of linked compartments 30. The carrier 16 is disposed within the handle 10 and is selectively positionable so that each of the compartments 30 is alignable with the carrier aperture 28 disposed within the reservoir 22.

In some embodiments, the carrier 16 is intended to be a replaceable unit. In other embodiments, the carrier 16 is intended to remain within the handle 10 during the useful life of the shaving apparatus 8. The carrier 16 can be configured to receive shaving aid material doses 14 in an unpackaged form (e.g., a form that adheres to, and therefore stays within, the walls of the compartment 30 when dehydrated), or in a packaged form (e.g., a form that is contained within or by packaging). In some embodiments, at least a portion of the packaging comprises a water permeable material that permits water to enter the compartment 30. In at least these embodiments, each of the compartments 30 within the carrier 16 is sealed to prevent the passage of water between it and an adjacent compartment 30. In other embodiments, each of the plurality of compartments 30 is sealed to prevent entry of water, and at least a portion of each compartment 30 comprises a material that can be ruptured to provide access to the shaving aid material dose 14.

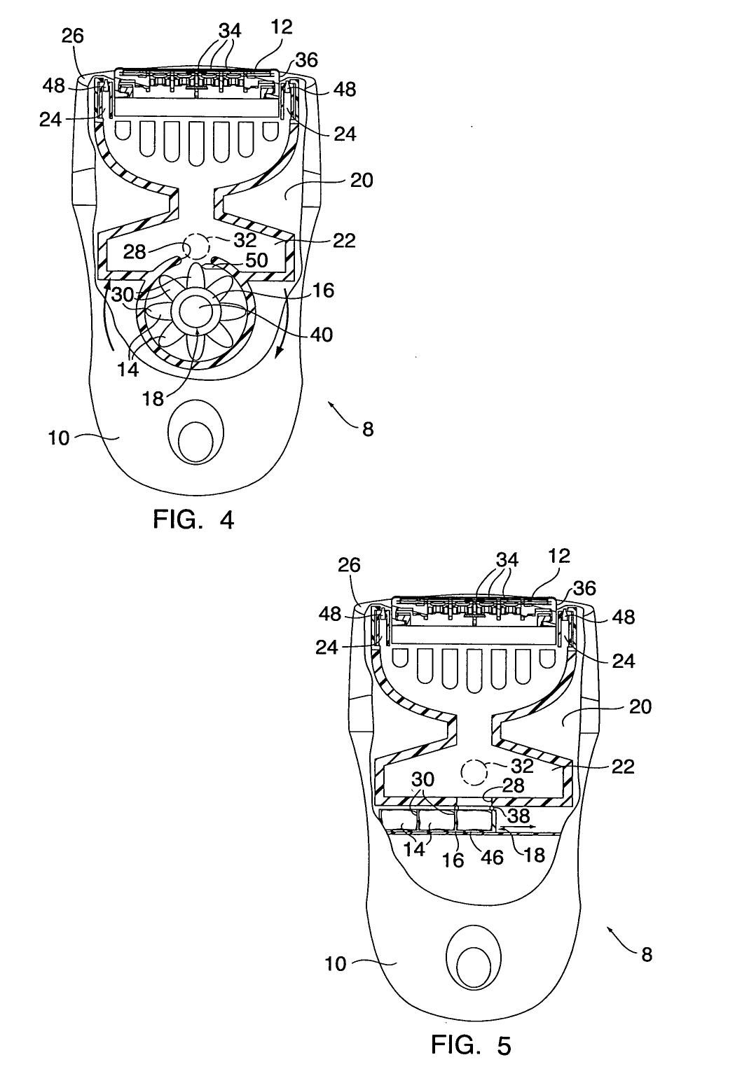

The actuator 18 is operable to move the carrier 16 to a position within the handle 10 wherein at least one of the shaving aid material doses 14 can be hydrated to produce a flowable shaving aid material. At that position, a compartment 30 of the carrier 16 is aligned with the carrier aperture 28 disposed within the reservoir 22. Some embodiments include a seal 38 disposed between the carrier 16 and the reservoir 22 to limit fluid flow therebetween. In the embodiment shown in FIGS. 2 and 4, the actuator 18 includes a knob 40 connected to a wheel-shaped carrier 16. The carrier 16 is moved by rotating the knob 40.

In some embodiments, the actuator 18 is actuable in predetermined increments. Each increment of predetermined magnitude moves the carrier 16 an amount sufficient to align an adjacent compartment 30 with the carrier aperture 28. In an alternative embodiment, a ratchet mechanism 42 (see FIG. 3) can be used to incrementally rotate the carrier wheel 16. Depressing a button 44 portion of the ratchet mechanism 42 causes the carrier wheel 16 to rotate an amount sufficient to expose the next compartment 30. In another alternative embodiment, the actuator 18 is a linear slide 46 (see FIG. 5) that moves the carrier 18 side to side to align with the carrier aperture 28.

In those embodiments wherein at least a portion of each compartment 30 comprises a material that can be ruptured to provide access to the shaving aid material dose 14, the shaving apparatus 8 includes a member 50 for rupturing the packaging material. In some embodiments the member 50 is selectively actuable to rupture a packaged dose 14 of shaving aid material disposed adjacent the carrier aperture 28. In other embodiments, the member 50 is fixed. Actuating the carrier 16 to the position where one of the shaving aid material doses 14 is adjacent the reservoir aperture 28, causes the member 50 to rupture the packaging material for that dose 14.

In the operation of the shaving apparatus, the operator inserts a shaving aid material dose 14 into each compartment 30 of the carrier 16, or inserts a new replacement carrier 16 into the shaving apparatus 8. The replacement carrier 16 contains a shaving aid material dose 14 in each compartment 30. Depending on the type of actuator 18 used, the actuator 18 may be indexed to an initial position. In some embodiments, a compartment 30 of the carrier 16 is aligned with the carrier aperture 28 when the actuator 18 is in the initial position. In other embodiments, the actuator 18 is used to actuate a compartment 30 of the carrier 16 into alignment with the carrier aperture 28.

Water or other liquid (from the shaving environment or other source) is inserted into the reservoir 22, for example, through the water fill aperture 32. The shaving aid material dose 14 within the compartment 30 aligned with the carrier aperture 28 is exposed to the water. As a result, the shaving aid material dose 14 hydrates and creates shaving aid material in a form that has utility during the shaving process; e.g., liquid, gel, or cream form. The shaving aid material dose 14 subsequently passes out through the passages 24 to the region adjacent the razor cartridge 12. Metering holes or valves 48 may be used to create a desirable flow rate of shaving aid material dose 14 out of the passages 24. As stated above, each dose 14 creates a desirable amount of hydrated shaving aid material.

In some embodiments, the residual shaving aid material, if any, can be drained from the reservoir 22 after the shaving process is completed. In other embodiments, valves 24 can be used to prevent leakage of the residual shaving aid material.

Each time the shaving apparatus 8 is used, the actuator 18 is used to position another carrier compartment 30 and the shaving aid material dose 14 it contains into alignment with the carrier aperture 28. At the same time, the carrier compartment 30 that contains the remains, if any, of the exhausted dose of shaving aid material, is moved away. In those embodiments that include a seal 38 disposed between the carrier 16 and the reservoir 22, the used compartment is sealed off once it is moved.

The shaving apparatus 8 is then ready for the above-described process to be repeated. When all of the shaving aid material doses 14 have been used, the carrier 16 is refilled or replaced, depending on the type of carrier 16 used. In some embodiments, the shaving apparatus 8 includes an indicator that indicates how many unused shaving material doses are available. The indicator may, for example, be incorporated into the carrier 16 or the actuator 18, or some combination thereof.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A shaving apparatus, comprising:
a handle;
a razor cartridge having one or more razor blades, the razor cartridge attached to the handle;
a plurality of shaving aid material doses, each in a substantially dehydrated form;
a carrier operable to carry the shaving aid material doses within the handle; and
an actuator operable to move the carrier to a position within the handle wherein at least one of the shaving aid material doses can be hydrated to produce a flowable shaving aid material.

2. The shaving apparatus of claim 1, wherein the handle has a cavity and a reservoir disposed within the cavity, wherein the reservoir includes a first aperture.

3. The shaving apparatus of claim 2, wherein the actuator is operable to move the carrier to a position where one of the shaving aid material doses is adjacent the first aperture.

4. The shaving apparatus of claim 3, further comprising a seal disposed between the carrier and the reservoir.

5. The shaving apparatus of claim 3, wherein the carrier includes a plurality of compartments, and at least one of the plurality of shaving aid material doses is disposed in each compartment.

6. The shaving apparatus of claim 5, wherein at least a portion of each compartment comprises a water permeable material that permits water to enter the compartment.

7. The shaving apparatus of claim 6, wherein each of the compartments within the carrier is sealed to prevent the passage of water between it and an adjacent compartment.

8. The shaving apparatus of claim 5, wherein each of the plurality of compartments is sealed to prevent entry of water, and at least a portion of each compartment comprises a rupturable material.

9. The shaving apparatus of claim 8, further comprising a member for rupturing the rupturable material.

10. The shaving apparatus according to claim 9, wherein the member is disposed relative to the actuator such that actuating the carrier to the position where one of the shaving aid material doses is adjacent the first aperture causes the member to rupture the rupturable material.

11. The shaving apparatus of claim 1, wherein the carrier is wheel-shaped.

12. The shaving apparatus of claim 1, wherein the carrier is a disposable and includes a plurality of compartments, and at least one of the plurality of shaving aid material doses is disposed within each of the plurality of compartments.

13. The shaving apparatus of claim 2, wherein the actuator rotates the carrier relative to the reservoir.

14. The shaving apparatus of claim 13, wherein a portion of the actuator extends outside of the housing to permit engagement by a user.

15. The shaving apparatus of claim 14, wherein the actuator is actuable in predetermined increments.

16. The shaving apparatus of claim 2, further comprising one or more passages extending between the reservoir and a portion of the housing adjacent the razor cartridge.

17. The shaving apparatus of claim 1, wherein the carrier includes a plurality of compartments, and at least one of the plurality of shaving aid material doses is disposed in each compartment, and wherein all but one of the plurality of shaving aid material doses are sealed to prevent exposure to a liquid during use.

18. A shaving aid material carrier, comprising:
a plurality of compartments linked together; and
at least one dose of shaving aid material disposed in each compartment, wherein each shaving aid material dose is dehydrated.

19. The shaving aid material carrier of claim 18, wherein at least a portion of each compartment comprises a water permeable material that permits water to enter the compartment.

20. The shaving aid material carrier of claim 19, wherein each of the compartments is sealed to prevent the passage of water between it and an adjacent compartment.

21. The shaving aid material carrier of claim 18, wherein each of the plurality of compartments is sealed to prevent entry of water, and at least a portion of each compartment comprises a rupturable material.
